(19) United States
(12) Patent Application Publication
(10) Pub. No.: US 2022/0372328 A1
(43) Pub. Date: Nov. 24, 2022

(54) BITUMINOUS COATING COMPOSITIONS

(71) Applicant: WACKER CHEMIE AG, Munich (DE)

(72) Inventors: Kunjankumar SHAH, Dubai (AE); Zulfikar KUTTIYA, Dubai (AE)

(73) Assignee: Wacker Chemie AG, Munich (DE)

(21) Appl. No.: 17/771,974

(22) PCT Filed: Oct. 28, 2019
(86) PCT No.: PCT/EP2019/079346

§ 371 Date: Apr. 26, 2022

(51) Int. Cl. C09D 195/00; C09D 123/08

(52) U.S. Cl. CPC C09D 195/005; C09D 123/0853

(57) ABSTRACT

Aqueous coating compositions and methods for making and used for the same. The method includes providing 75 to 97 weight percent of bitumen (solid) and 3 to 20 weight percent of vinyl acetate-ethylene copolymers, wherein each is based on the dry weight of the bituminous coating compositions. Mixing the bitumen, the one or more vinyl acetate-ethylene copolymers and optionally one or more additives. Where the bitumen and/or the vinyl acetate-ethylene copolymers are applied in the form of aqueous dispersions. Where the one or more vinyl acetate-ethylene copolymers are based on ≥50 weight percent, based on the total weight of the vinyl acetate-ethylene copolymers, of vinyl acetate and ≥90 weight percent, based on the total weight of the vinyl acetate-ethylene copolymers, of vinyl acetate and ethylene.

The invention relates to aqueous coating compositions containing bitumen and one or more vinyl acetate-ethylene copolymers, to processes for preparing the aqueous coating compositions as well as to their use in the construction sector, such as water-barrier coatings or roofing.

Bitumen finds various uses in the construction sector, for example in coating compositions for covering concrete, particularly the exterior of flat roofs, walls or basements. Bitumen is generally known as non-destillable residue resulting from petroleum refining. Bituminous coating compositions may contain additionally emulsifiers or additives for instance.

JP3031340 deals with asphalt emulsions for repairing cracks on concrete or asphalt paved roads and teaches for that purpose compositions comprising asphalt emulsions, copolymers of acrylic acid (esters) and rubber latex, like styrene-butadiene copolymers. JP59189145 describes architectural compositions containing asphalt and ethylene-vinyl acetate copolymers. The term ethylene-vinyl acetate copolymer implies that ethylene is the major monomer-unit. U.S. Pat. No. 4,722,953 claims the preparation of asphaltic coating agents by blending heated asphalt and heated aqueous polymer emulsions based on ethylene, vinyl acetate or acrylates. JP9328594 discloses vibration-dampening compositions based on aqueous asphalt, polyvinyl acetate emulsions, flaky inorganic fillers and aqueous tyre. EP2221345 as well as EP1716207 describe aqueous coating compositions comprising bitumen, emulsifiers, aggregates and optionally rubbers, thermoplastic resins, thermosetting resins or elastomers. In practice, particularly styrene-butadiene copolymers or styrene-acrylic copolymers have so far been applied as thermoplastic resins in bituminous compositions.

Against this background, the object was to provide aqueous bituminous coating compositions which dry quickly and, therefore, allow the preparation of bituminous coatings in a time-efficient manner. Additionally, it was preferred that the bituminous coatings show high elastic recovery and at the same time high elongation as well as reduced tackiness.

The invention provides aqueous coating compositions containing bitumen, one or more vinyl acetate-ethylene copolymers and optionally one or more additives, characterized in that one or more vinyl acetate-ethylene copolymers are based on

≥50 weight percent of vinyl acetate and
≥90 weight percent of vinyl acetate and ethylene,
the figures in weight percent being based in each case on the total weight of the vinyl acetate-ethylene copolymers.

The instant aqueous coating compositions are abbreviated in the following as bituminous coating compositions.

Bitumen is well known in the art and generally available by distillation of crude oil during petroleum refining, preferably by vacuum distillation of crude oil, for instance at up to 425° C. at a pressure of 10 mbar to 150 mbar. Bitumen comprises generally the non-distillable fraction, also called (vacuum) residue, of such distillation. Preferably bitumen is obtained by petroleum refining directly. Bitumen is preferably based on alkanes, cycloalkanes, aromatics and heteromolecules containing sulphur, oxygen, nitrogen or metals.

Bitumen contains for instance 80.2 to 84.3 weight percent of carbon, 9.8 to 10.8 weight percent of hydrogen, 0.2 to 1.2 weight percent of nitrogen, 0.9 to 6.6 weight percent of sulphur, 0.4 to 1.0 weight percent of oxygen and optionally additionally metals. Bitumen becomes liquid at a temperature between preferably 140° C. and 170° C. Bitumen has a molecular weight of preferably 300 to 10000 Dalton, particularly 300 to 1500 Dalton.

Bitumen might be modified in common way, such as by air rectification, for instance by treatment of bitumen with air at up to 300° C., or by residual oil solvent extraction.

Bitumen is preferably applied in the form of aqueous dispersions which may contain further ingredients, such as lubricants, extenders, thickeners, adhesion promotors or fibres, and preferably emulsifiers. The solid content of such aqueous bituminous dispersions is preferable 40% to 80%, more preferably 50% to 70%.

The aqueous bituminous dispersions contain preferably 85 to 99 weight percent, more preferably 90 to 95 weight percent of bitumen (solid), based on the dry weight of the aqueous bituminous dispersion.

Emulsifiers may be cationic, nonionic or preferably anionic, examples being anionic surfactants, such as fatty acid salts, alkyl sulfates with a chain link of 8 to 18 C atoms, alkyl or alkylaryl ether sulfates with 8 to 18 C atoms in the hydrophobic radical and up to 40 ethylene oxide or propylene oxide units, alkyl- or alkylaryl sulfonates having 8 to 18 C atoms, esters and monoesters of sulfosuccinic acid with monohydric alcohols or alkylphenols, or nonionic surfactants, such as alkyl polyglycol ethers or alkylaryl polyglycol ethers having 8 to 40 ethylene oxide units. Emulsifiers are contained in the aqueous bituminous dispersions in amounts of preferably 0.1 to 10 weight percent, more preferably 1 to 5 weight percent, based on the dry weight of the aqueous bituminous dispersion.

The further ingredients are contained to preferably 5 weight percent, more preferably 0.1 to 3 weight percent, based on the dry weight of the aqueous bituminous dispersion.

The aqueous bituminous dispersions generally do not contain vinyl acetate-ethylene copolymers.

Aqueous bituminous dispersions are obtainable, for instance, by heating bitumen to 100° C. to 200° C., preferably 140° C. and 170° C. and, subsequently, adding water and optionally emulsifiers and optionally further ingredients. This can be done in a common way, such as in a colloid mill for instance. No vinyl acetate-ethylene copolymer is added as this stage generally.

Bitumen differs from asphalt, pitch or tar, as skilled persons know, with respect to composition for instance. Asphalt in the sense of the instant invention refers to mixtures comprising bitumen and mineral materials, such as sand, chippings, gravel, blast furnace slag, steel mill slag or metal smelter slag. Asphalt contains preferably 1 to 60 weight percent, more preferably 5 to 30 weight percent of mineral materials, based on the dry weight of asphalt. Pitch or tar are available by high-temperature pyrolysis of bituminous coals, for instance at >800° C.

The bituminous coating compositions contain preferably 40 to 97 weight percent, more preferably 50 to 95 weight percent, even more preferably 60 to 93 weight percent, again more preferably 70 to 92 weight percent and most preferably 75 to 90 weight percent of bitumen (solid), based on the dry weight of the bituminous coating compositions.

The bituminous coating compositions may contain further additives, such as defoamer, biocides, wetting agents, thickener, extending agents, chemical modifiers or pigments. Additives might be contained in the bituminous coating compositions with preferably 0 to 10 weight percent, more preferably 0.1 to 5 weight percent, based on the dry weight of the bituminous coating compositions.

Thickener might be contained in the bituminous coating compositions, but it is also possible to omit thickener.

The bituminous coating compositions contain preferably 1 to 40 weight percent, more preferably 3 to 30 weight percent, even more preferably 5 to 20 weight percent and most preferably 7 to 15 weight percent of vinyl acetate-ethylene copolymers, based on the dry weight of the bituminous coating compositions.

The total amount of bitumen (dry) and vinyl acetate-ethylene copolymers contained in the bituminous coating composition is preferably 80 to 99.5 weight percent, more preferably 85 to 99 weight percent, even more preferably 90 to 98.9 weight percent and most preferably 95 to 98.5 weight percent, based on the dry weight of the bituminous coating composition.

The vinyl acetate-ethylene copolymers are based on preferably 60 to 100 weight percent, more preferably 70 to 95 weight percent and most preferably 75 to 85 weight percent of vinyl acetate, based on the total weight of the vinyl acetateethylene copolymers.

The vinyl acetate-ethylene copolymers are based on preferably 0 to 40 weight percent, more preferably 5 to 30 weight percent and most preferably 15 to 25 weight percent of ethylene, based on the total weight of the vinyl acetate-ethylene copolymers.

The vinyl acetate-ethylene copolymers are based on preferably 95 weight percent, more preferably 97 weight percent of vinyl acetate and ethylene, based on the total weight of the vinyl acetate-ethylene copolymers. Most preferably, the vinyl acetate-ethylene copolymers are not based on ethylenically unsaturated monomers other than vinyl acetate and ethylene.

The vinyl acetate-ethylene copolymers may be based on one or more further ethylenically unsaturated monomers, preferably selected from the group encompassing vinyl esters other than vinyl acetate, (meth)acrylic esters, vinylaromatics, dienes and vinyl halides, and optionally further monomers copolymerizable therewith. Preferred vinyl acetate-ethylene copolymers are not based on such further ethylenically unsaturated monomers.

Examples for vinyl esters other than vinyl acetate are vinyl propionate, vinyl butyrate, vinyl 2-ethylhexanoate, vinyl laurate, 1-methylvinyl acetate, vinyl pivalate and vinyl esters of α-branched monocarboxylic acids having 9 to 11 C atoms, for example VeoVa9® or VeoVa10® (trade names of the company Resolution).

Examples for vinylaromatics are styrene, methylstyrene and vinyltoluene. Preferred vinyl halide is vinyl chloride. Preferred dienes are 1,3-butadiene and isoprene.

Examples for (meth)acrylic esters are methyl acrylate, methyl methacrylate, ethyl acrylate, ethyl methacrylate, propyl acrylate, propyl methacrylate, n-butyl acrylate, n-butyl methacrylate, tert-butyl acrylate, tert-butyl methacrylate, 2-ethylhexyl acrylate. Preferred are methyl acrylate, methyl methacrylate, n-butyl acrylate, tert-butyl acrylate and 2-ethylhexyl acrylate.

Optionally it is possible for 0% to <10% by weight, based on the total weight of the monomer mixture, of auxiliary monomers to be copolymerized. It is preferred to use 0.1% to 5% by weight of auxiliary monomers. Examples of auxiliary monomers are ethylenically unsaturated monocarboxylic and dicarboxylic acids, preferably acrylic acid, methacrylic acid, fumaric acid and maleic acid; ethylenically unsaturated carboxamides and carbonitriles, preferably acrylamide and acrylonitrile; monoesters and diesters of fumaric acid and maleic acid, such as the diethyl and diisopropyl esters, and also maleic anhydride; ethylenically unsaturated sulphonic acids and/or their salts, preferably vinylsulphonic acid, 2-acrylamido-2-methylpropanesulphonic acid. Further examples are precrosslinking comonomers such as polyethylenically unsaturated comonomers, examples being diallyl phthalate, divinyl adipate, diallyl maleate, allyl methacrylate or triallyl cyanurate, or postcrosslinking comonomers, examples being acrylamido glycolic acid (AGA), methylacrylamido glycolic acid methyl ester (MAGME), N-methylolacrylamide (NMA), N-methylolmethacrylamide, N-methylol allylcarbamate, alkyl ethers such as the isobutoxy ether or esters of N-methylolacrylamide, of N-methylolmethacrylamide and of N-methylol allylcarbamate. Also suitable are epoxide-functional comonomers such as glycidyl methacrylate and glycidyl acrylate. Further examples are silicon-functional comonomers, such as acryloyloxypropyltri(alkoxy)- and methacryloyloxypropyltri(alkoxy)silanes, vinyltrialkoxysilanes and vinylmethyldialkoxysilanes, where alkoxy groups that may be present include, for example, ethoxy radicals and ethoxypropylene glycol ether radicals. Mention may also be made of monomers having hydroxyl groups or CO groups, examples being hydroxyalkyl acrylates and methacrylates such as hydroxyethyl, hydroxypropyl or hydroxybutyl acrylate or methacrylate, and also compounds such as diacetoneacrylamide and acetylacetoxyethyl acrylate or methacrylate. Preferred auxiliary monomers are ethylenically unsaturated monocarboxylic and dicarboxylic acids, ethylenically unsaturated sulphonic acids and/or their salts and silicon-functional comonomers.

The vinyl acetate-ethylene copolymers are based on preferably <10 weight percent, more preferably ≤5 weight percent of further ethylenically unsaturated monomers and/or auxiliary monomers, based on the total weight of the vinyl acetateethylene copolymers. The vinyl acetate-ethylene copolymers are based on preferably ≤10 weight percent, more preferably ≤5 weight percent of (meth)acrylic esters, based on the total weight of the vinyl acetate-ethylene copolymers. Most preferably, the vinyl acetate-ethylene copolymers do not contain monomer units of further ethylenically unsaturated monomers and/or auxiliary monomers, particularly not (meth)acrylic esters units.

The monomer selection, and the selection of the weight fractions of the comonomers, are made such as to result in a glass transition temperature, Tg, of −50° C. to +30° C., preferably −40° C. to +10° C., more preferably −30° C. to 0° C. The glass transition temperature Tg of the polymers can be determined in a known way by means of Differential Scanning calorimetry (DSC). The Tg may also be calculated approximately in advance by means of the Fox equation. According to Fox T. G., Bull. Am. Physics Soc. 1, 3, page 123 (1956), the following holds: 1/Tg=x1/Tg1+x2/Tg2++xn/Tgn, where xn is the mass fraction (% by weight/100) of the monomer n, and Tgn is the glass transition temperature, in kelvins, of the homopolymer of the monomer n. Tg values for homopolymers are listed in Polymer Handbook 2nd Edition, J. Wiley & Sons, New York (1975).

The vinyl acetate-ethylene copolymers are prepared generally in aqueous medium and preferably by the emulsion or suspension polymerization process—as described in DE102008043988, for example. The vinyl acetate-ethylene copolymers in these cases are generally obtained in the form of aqueous dispersions. During the polymerization it is possible to use the common protective colloids and/or emulsifiers, as described in DE102008043988. Respective emulsifiers are described above. The protective colloids may be anionic or preferably cationic or nonionic. Preference is also given to combinations of cationic and nonionic protective colloids. Preferred nonionic protective colloids are polyvinyl alcohols. Preferred cationic protective colloids are polymers which carry one or more cationic charges, as described in E. W. Flick, Water Soluble Resins—an Industrial Guide, Noyes Publications, Park Ridge, N.J., 1991, for example.

The vinyl acetate-ethylene copolymers are preferably stabilized by one or more protective colloids. More preferably, the vinyl acetate-ethylene copolymers are applied in the form of aqueous dispersions stabilized by one or more protective colloids. Preferred as protective colloids are polyvinyl alcohols, particularly partially hydrolysed or fully hydrolysed polyvinyl alcohols having a degree of hydrolysis of 80 to 100 mol %, more particularly partially hydrolysed polyvinyl alcohols having a degree of hydrolysis of 80 to 94 mol % and/or a Höppler viscosity, in 4% strength aqueous solution, of 1 to 30 mPas (Höppier method at 20° C., DIN 53015). The stated protective colloids are obtainable by means of processes known to the skilled person, and are added generally in an amount totalling 1% to 20% by weight, based on the total weight of the monomers, in the polymerization.

The vinyl acetate-ethylene copolymers are preferably not stabilized by emulsifiers. Examples of emulsifiers are given above.

The vinyl acetate-ethylene copolymers in the form of aqueous dispersions have solid contents of preferable 30% to 75%, more preferably 45% to 60%.

Bituminous coating compositions contain preferably ≥80 weight percent, more preferably ≥90 weight percent and even more preferably ≥95 weight percent of vinyl acetate-ethylene copolymers, based on the total weight of polymers from ethylenically unsaturated monomers. Most preferably, the bituminous coating composition do not contain polymers from ethylenically unsaturated monomers other than vinyl acetate-ethylene copolymers, particularly the bituminous coating composition do not contain styrene-butadiene-copolymers, styrene-acrylic copolymers or copolymers containing (meth)acrylic ester units. By this, the drying time or the workability of the bituminous coating compositions or the elongation properties of the bituminous coating can be improved.

The bituminous coating compositions have solid contents of preferable 50% to 80%, more preferably 60% to 70%.

The invention further provides methods for preparing aqueous coating compositions by mixing bitumen, one or more vinyl acetate-ethylene copolymers and optionally one or more additives, characterized in that one or more vinyl acetateethylene copolymers are based on

≥50 weight percent of vinyl acetate and
≥90 weight percent of vinyl acetate and ethylene,
the figures in weight percent being based in each case on the total weight of the vinyl acetate-ethylene copolymers.

The bituminous coating compositions may be obtained by mixing bitumen, preferably in the form of aqueous dispersions, and one or more vinyl acetate-ethylene copolymers, preferably in the form of aqueous dispersions, and optionally one or more additives.

The preparation of bituminous coating compositions is performed preferably at temperatures from 10° C. to 50° C., particularly preferred at temperatures from 15° C. to 30° C. and most preferred at room temperature.

The mixing can be carried out in conventional mixers, such as stirrers, dissolvers or in a mill.

The bituminous coating compositions may be applied in typical applications for bitumen, preferably as coating agents for roofings, wall surfaces, water pipes, basements, foundations, on paper or cardboard for moisture resistant packaging, lumber for building construction or steel surfaces as a corrosion barrier, particularly in exterior applications. The bituminous coating compositions may also be used for preparing sound deadening coatings, bitumen paints or waterproofing or sealing materials. Most preferred is the use of the bituminous coating compositions as water-barrier coating, roofing coatings or paints, such as wall surface or basement paints.

The bituminous coating compositions may be applied to substrates in customary fashion, for instance by brushing, spraying or dipping or by means of doctor blades, rollers, trowels or paddles.

The bituminous coating compositions are preferably applied directly to the surface of substrates, e.g. without intermediate layer, like felt or paper. More preferably, the bituminous coating compositions are applied as a primer.

Examples of substrates are concrete, or generally mineral substrates or steel.

The bituminous coating compositions are applied typically at ambient temperatures, i.e. in general at temperatures from 5 to 50° C., more particularly from 15 to 35° C.

The bituminous coating compositions are applied to a substrate in a coating thickness of preferably 0.1 to 10 mm, more preferably 2 to 5 mm and most preferably 2 to 3 mm. In case of roofings, the coating thickness is preferably 1 to 5 mm, more preferably 2 to 3 mm. In case of other coatings, the coating thickness is preferably 0.1 to 3 mm, more preferably 0.1 to 0.9 mm.

Surprisingly, the instant bituminous coating compositions dry faster compared to conventional bituminous systems and lead to non-tacky surfaces more quickly, so that coatings are accessible in a more time efficient way. Advantageously, the instant coatings show high elastic recovery and at the same time high elongation and additionally reduced tack. Against this, tacky systems adhere to processing equipment, like brush or worker's boots, and suffer dirt pick-up during drying. Such problems can be overcome with the instant approach. The instant bituminous coating compositions meet the desired processing requirements, like workability. The coatings have advantageous properties, like adhesion, wear resistance, resistance to hydraulic pressure, particularly water resistance with hydraulic pressure.

The examples which follow serve for detailed elucidation of the invention and should in no way be understood to constitute any restriction.

### Preparation of the Bituminous Coating Compositions:

All components of the bituminous coating formulation are given in Table 1 and were homogeneously mixed in a laboratory stirrer at room temperature.

TABLE 1
bituminous coating composition:

| | | wt.-parts |
|---|---|---|
| polymer dispersion^{a)} | | |
| bitumen emulsion^{b)} | SS-1H | 83.40 |
| defoamer | BYK-037 | 0.10 |
| biocide | Proxel 106 | 0.20 |
| wetting agent | DOW NP-10 | 0.20 |
| thickener | Hisol 305 | 1.00 |
| additional water | | 2.28 |

^{a)}specified for each Inventive/Comparative Example;
^{b)}aqueous bitumen emulsion containing emulsifier and having a solid content of 60%.

### INVENTIVE EXAMPLE 1 (IEX. 1)

18.18 parts by weight of an aqueous dispersion of a polyvinyl alcohol stabilized copolymer based on 80 wt. % vinyl acetate and 20 wt. % ethylene (solids content: 55%) were applied.

### COMPARATIVE EXAMPLE 2 (CEX. 2)

15.15 parts by weight of an aqueous dispersion of a styrenebutadiene-rubber having a glass transition temperature of −51° C. and a solids content of 66% were applied.

### COMPARATIVE EXAMPLE 3 (CEX. 3)

20.62 parts by weight of an aqueous dispersion of a styrenebutadiene-rubber having a glass transition temperature of −5° C. and a solids content of 48.5% were applied.

### Performance Testing

### Drying:

The bituminous coating composition of the respective Example 1˜3 was applied to a concrete substrate with a roller at 23° C. and 50% relative humidity and dried under these conditions. The time to formation of a dry and non-tacky bitumen coating was determined by finger testing and is given in Table 2 for all (Comparative) Examples.

### Elongation:

The bituminous coating composition of the respective Example 1-3 was given into a silicone mold. After drying for 48 hours, the obtained coating had thickness of 2 mm and was taken from the mold and cut into test panels of 10 cm length and 0.5 cm width.

The elongation of the panels was determined according to DIN EN ISO 527-1 using Zwick/Roell Z010 with 500N loadcell, the instron test device Model 4501, a test rate of 50 mm/min and a distance between the jaws of 115 mm.

The entire test including the preparation of the bituminous coating composition and the test panel as well as the elongation test was performed at 23° C. and 50% relative humidity.

This test was repeated with two further samples.

The average of the test results is given in Table 2.

### Elastic Recovery:

The bituminous coating composition of the respective Example 1-3 was given into a silicone mold. After drying for 48 hours, the obtained coating had thickness of 2 mm and was taken from the mold and cut into test panels of 10 cm length and 0.5 cm width.

The test panel was elongated manually to 20 cm.

Afterwards, the samples were released and after 3 min the length of the test panel was determined.

The entire test including the preparation of the bituminous coating composition and the test panel as well as the test for elastic recovery was performed at 23° C. and 50% relative humidity.

The elastic recovery is the quotient of the determined length of the test panel before the test and the length of the test panel after the test.

This test was repeated with two further samples.

The average of the test results is given in Table 2.

TABLE 2
Test results:

| | IEx. 1 | CEx. 2 | CEx. 3 |
|---|---|---|---|
| drying [min] | 27 | 34 | 31 |
| elongation [%] | 1350 | 1400 | 350 |
| elastic recovery [%] | 70.0 | 53.7 | 66.7 |

1-10. (canceled)

11. Method for preparing aqueous coating compositions, comprising the steps of:
providing 75 to 97 weight percent of bitumen (solid) and 3 to 20 weight percent of vinyl acetate-ethylene copolymers, wherein each is based on the dry weight of the bituminous coating compositions;
mixing the bitumen, the one or more vinyl acetate-ethylene copolymers and optionally one or more additives, wherein the bitumen and/or the vinyl acetate-ethylene copolymers are applied in the form of aqueous dispersions, wherein the one or more vinyl acetate-ethylene copolymers are based on
≥50 weight percent, based on the total weight of the vinyl acetate-ethylene copolymers, of vinyl acetate and
≥90 weight percent, based on the total weight of the vinyl acetate-ethylene copolymers, of vinyl acetate and ethylene.

12. The method of claim 1, wherein the aqueous coating compositions contain 75 to 95 weight percent of bitumen (solid), based on the dry weight of the aqueous coating compositions.

13. The method of claim 1, wherein the aqueous coating compositions contain 3 to 15 weight percent of vinyl acetate-ethylene copolymers, based on the dry weight of the aqueous coating compositions.

14. The method of claim 1, wherein the total amount of bitumen (dry) and vinyl acetate-ethylene copolymers contained in the aqueous coating compositions is 80 to 99.5 weight percent, based on the dry weight of the aqueous coating compositions.

15. The method of claim 1, wherein the vinyl acetate-ethylene copolymers are based on 60 to 95 weight percent of vinyl acetate, based on the total weight of the vinyl acetate-ethylene copolymers.

16. The method of claim 1, wherein the vinyl acetate-ethylene copolymers are based on 5 to 40 weight percent of ethylene, based on the total weight of the vinyl acetate-ethylene copolymers.

17. The method of claim 1, wherein the vinyl acetate-ethylene copolymers are based on 95 weight percent of vinyl acetate and ethylene, based on the total weight of the vinyl acetate-ethylene copolymers.

18. The method of claim 1, wherein the vinyl acetate-ethylene copolymers are stabilized by one or more protective colloids.

19. The method of claim 1, wherein the aqueous coating compositions are used as coating agents for roofings, wall surfaces, water pipes, basements, foundations, paper or cardboard for moisture resistant packaging, lumber for building construction or steel surfaces as a corrosion barrier or for preparing sound deadening coatings, bitumen paints or waterproofing or sealing materials.
